(19) United States
(12) Patent Application Publication
(10) Pub. No.: US 2008/0159922 A1
(43) Pub. Date: Jul. 3, 2008

(54) Flue-Gas Purification System

(75) Inventors: Harald Sauer, Frankfurt (DE); Frank Leuschke, Dormagen (DE)

Correspondence Address: HARNESS, DICKEY & PIERCE, P.L.C., P.O. BOX 828, BLOOMFIELD HILLS, MI, 48303, US

(73) Assignee: LURGI LENT JES AG, Dusseldorf (DE)

(21) Appl. No.: 11/578,636

(22) PCT Filed: Sep. 22, 2004
(86) PCT No.: PCT/EP2004/010592

§ 371 Date: Oct. 24, 2007

(51) Int. Cl. B01D 53/74

(52) U.S. Cl. 422/139

(57) ABSTRACT

The invention relates to a flue gas purification device comprising a fluidized reactor and a separation unit, which is placed downstream of the fluidized reactor, wherein the reactor space of the fluidized reactor presents, orthogonal to the gas flow direction, an essentially rectangular cross section, the relation of width with respect to depth of which can be variably set depending on the cross sectional size, which is required for the flue gas volume flow to be purified.

The invention relates to a flue gas purification device comprising a fluidized reactor and a separation unit, which is placed downstream of the fluidized reactor.

Such flue gas purification devices are known. They serve for carrying out methods for the separation of pollution gases, such as for example HCl, HF, SO₂, and if absorbents, such as hearth type furnace coke or active carbon are added, also for the separation of dioxins, furans and heavy metals, e.g. mercury presenting high efficiencies. In such exhaust gas purification devices, a flue gas is supplied via a supply pipe having a corresponding cross section to a fluidized reactor. A sorbent is contained in the reactor or is supplied to this one. Depending on different parameters, such as for example the gas flow rate, the particle size and the particle weight of the sorbent or the temperature etc., described by the dimensionless characteristic numbers Re, Fr, Ar, a fluid bed is formed. The reactor is operated with a circulating fluid bed or with a flue flow process. The flue gas and the sorbent react with each other in the fluid bed. Due to these reactions, pollution gases can be separated from the flue gas. The flue gas is guided, together with the carried separation residues, from the fluid bed via a transition piece to a downstream separation unit, such as for example a fibre filter or electric filter. In this separation unit, the residues are separated from the flue gas. The purified flue gas can be evacuated into the atmosphere, whereas the separated solids are returned to the fluid bed or collected therein and are then evacuated or supplied to a further use.

For fluidic reasons and in order to obtain a symmetric distribution of the solids, the reactors known from the state of the art for flue gas purification are realized with a round gas flow cross section. The size of the cross section of the reactor is determined by the volume flow of the flue gas to be purified and the flow rate required in the reactor. The flue gas channels, which enter and leave the reactor, usually have a rectangular cross section. Units, such as for example vessel or filter, which are placed upstream or downstream of the reactor, also have a rectangular gas flow cross section. Transition pieces are used between the flue gas channels and the reactor, by means of which the necessary cross section transitions from round to angular or from angular to round can be realized. The use of such transition pieces disadvantageously entails a higher material consumption and leads to a general increase of the costs of a flue gas purification device.

In practice, it is often an object to retrofit existing power stations or installations with a flue gas purification device. In such a case it is not always possible, under the given, partially narrow space conditions of the power station or installation, to install the reactor in the existing flue gas path because of its definitely given cross sectional dimensions. The rebuilding measures, such as a displacement or exchange of operative, already existing aggregates, which become necessary thereby, lead to a considerable increase of the costs for a subsequent installation of a flue gas purification device.

If separation units having a large cross section, such as for example bulky electric filters, are used within the flue gas purification device, the use of a reactor with a round reactor cross section of given geometry makes it very difficult to assure a uniform gas flow over the entire cross-sectional area of the filter. For very big installations, a uniform gas flow towards such separation units can only be assured with high constructive efforts. In particular the use of reactors having a round reactor cross section entails a fixedly determined installation of the plant. This causes problems both for the new design of a flue gas purification device and for the retrofitting of flue gas purification devices. The necessary shifting or displacement of plant components entails higher costs.

Based upon this state of the art, it is the object of the invention to propose a generic flue gas purification device, which, in comparison to the state of the art, requires less material, saves costs and can also be realized or retrofitted in particular for a use under narrow space conditions.

This aim is achieved by a flue gas purification device, in which the reactor space of the fluidized reactor presents, orthogonal to the gas flow direction, an essentially rectangular cross section, the relation of width with respect to depth of which can be variably set depending on the cross sectional size, which is required for the flue gas volume flow to be purified.

The geometry of such a reactor can be advantageously varied with constant cross section and can be well adapted to narrow space conditions. Due to the form of the cross section, the respectively required gas flow cross section can be realized by means of different depth-width relations of the reactor cross section, whereby the reactor can be for example realized with a small depth and a large width or with a small width and a large depth according to the requirements. A variation of the dimensions of the gas flow cross section of the reactor offers the possibility that already existing equipment, such as filters, can be further used for example in the context of a retrofitting, which leads to further cost savings.

Reactors having reactor spaces with a rectangular cross section can be simply manufactured at low costs. For the use of a fluidized reactor with rectangular cross section, the formerly required transition pieces between the rectangular cross section of flue gas channels or vessel or separation units and the round cross section of the reactor can be advantageously omitted. The saving of material, which is related therewith, enables a considerable cost saving.

The rectangular cross section of the reactor space also improves the gas flow towards the separation units considerably. A uniform realization of the cross section, through which the flue gas flows, should be provided for the entire flue gas purification device. By avoiding modifications of the cross sectional form, unnecessary turbulences and dead flow areas in the flue gas path are almost prevented. Due to the rectangular cross sectional form of the reactor space, the entire system can be designed with a more compact and flexible structure, whereby also savings with respect to the steel structure become possible. According to a preferred embodiment of the invention, the fluidized reactor presents an essentially rectangular outer contour corresponding to the reactor space.

According to an embodiment of the present invention, the cross sectional width and/or cross sectional depth of the reactor space of the fluidized reactor corresponds to the cross sectional dimensions of the flue gas channels of units of the flue gas purification device upstream and/or downstream the reactor. If the dimensions of the reactor space of the fluidized reactor and the dimensions of the flue gas channels of units of the flue gas purification device, which are connected to the fluidized reactor, are adjusted to each other, turbulences and dead flow areas inside the flue gas path are almost prevented, which favours an undisturbed operation of the flue gas purification device. Furthermore, the gas flow of all units is improved, whereby it becomes unnecessary to use transition pieces for increasing or reducing the cross section, through which the gas flows, which in turn leads to a cost saving as well as a reduction of the required building space for the flue gas purification device.

According to another advantageous embodiment of the invention, the fluidized reactor at least comprises one diffuser nozzle having an advantageously round or rectangular cross section. In another embodiment, which is especially suitable for bigger reactors, the diffuser nozzles are advantageously juxtaposed in one or more rows. Another embodiment of the invention advantageously provides that the diffuser nozzles are placed in an offset disposition. Due to the variable design of the disposition of the diffuser nozzles, nearly any cross sectional form of the reactor space becomes possible. A variation of the number of diffuser nozzles still improves these possibilities. In contrast to the round fluidized reactor, in which either one single nozzle or seven nozzles are used, since these nozzle numbers enable dispositions of the nozzles in the reactor cross section, which are favourable for the flow, the number and disposition of the diffuser nozzles in a reactor of a flue gas purification device according to the invention having a rectangular cross section as well as the nozzle volume flow can be flexibly chosen under economic aspects according to the respective requirements.

In one embodiment of the invention, the reactor can be operated with a circulating fluid bed. An alternative. embodiment provides that the reactor is a flue flow absorber. The use of fluidized reactors having a circulating fluid bed or of flue flow absorbers advantageously permits the application of the invention within a large range of flow rates.

In another embodiment of the invention, the separation unit advantageously is an electric filter. Due to the good gas flow in the electric filter, which is achieved by cross sectional geometries that are adapted to each other, the electric filter can be operated with a high efficiency. By using different filter mechanisms, the invention advantageously can be flexibly adapted to the respective composition of the flue gas to be purified and to the spatial arrangement of the plant. Apart from the use of electric filters and bag filters as separation unit, also other separation units, such as for example deflection separators, lamelia separators or cyclones can be used.

According to another advantageous embodiment, a pre-separation device is arranged in a flue gas channel between the fluidized reactor and the separation unit. By means of such a pre-separation device, the flue gas leaving the fluidized reactor can be pre-purified before the real filtration, whereby the life of the used filter is prolonged.

In a preferred embodiment, a fibre filter is used as separation unit, which, according to another embodiment, can be placed such that it is rotated around the vertical by 90°, which is an advantage in comparison to the former disposition thereof according to the state of the art. The existing building space can be advantageously better used by this arrangement of the fibre filter. The saved building space is available for the installation of the fluidized reactor having a rectangular cross section.

Other advantages and characteristics of the present invention will appear from the following description of the drawings and of examples of a preferred, non-limiting embodiment. Herein:

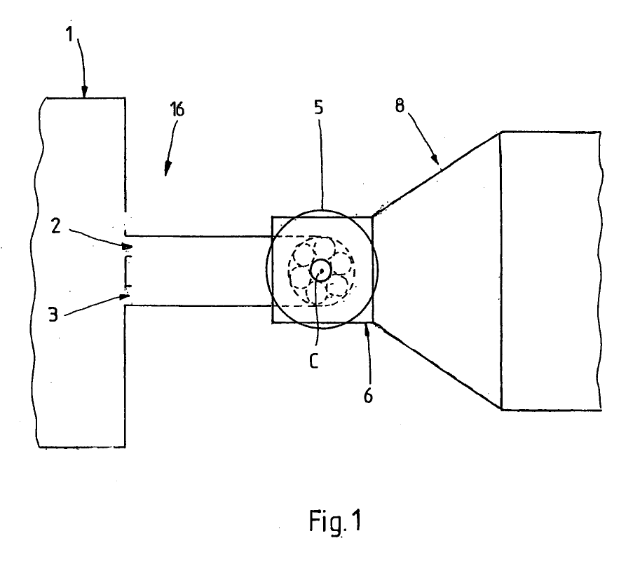

FIG. 1 is a schematic view of a flue gas purification device according to the state of the art having a round reactor space cross section,

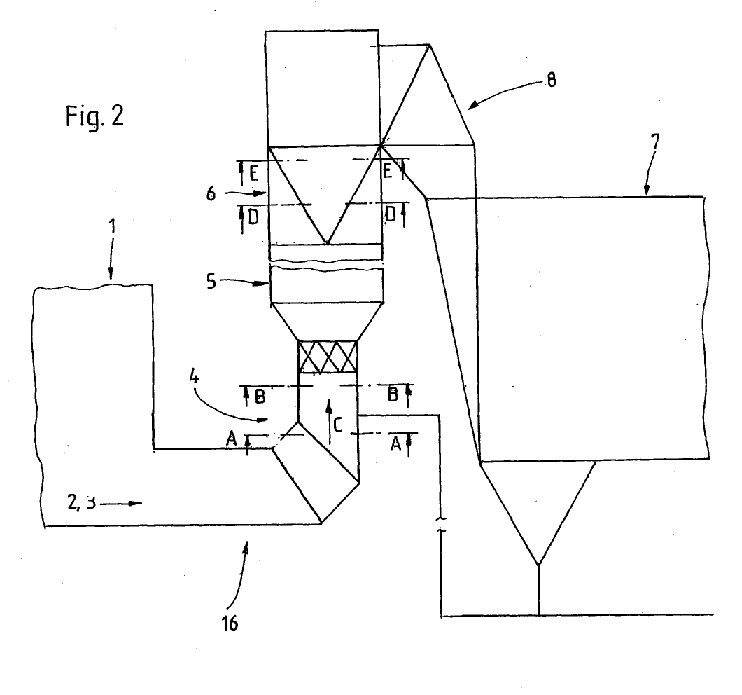

FIG. 2 is a schematic side view of the flue gas purification device from FIG. 1,

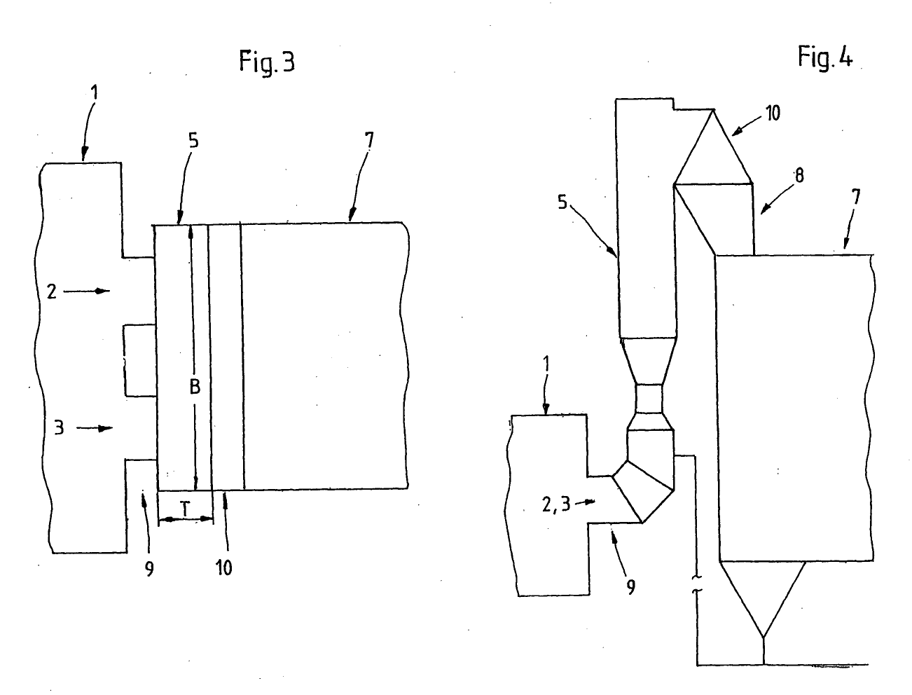

FIG. 3 is a schematic plan view of a flue gas purification device according to the invention having a rectangular reactor space cross section,

FIG. 4 is a schematic side view of the flue gas purification device from FIG. 3,

FIG. 5 is a schematic plan view of the arrangement of a filter according to the state of the art,

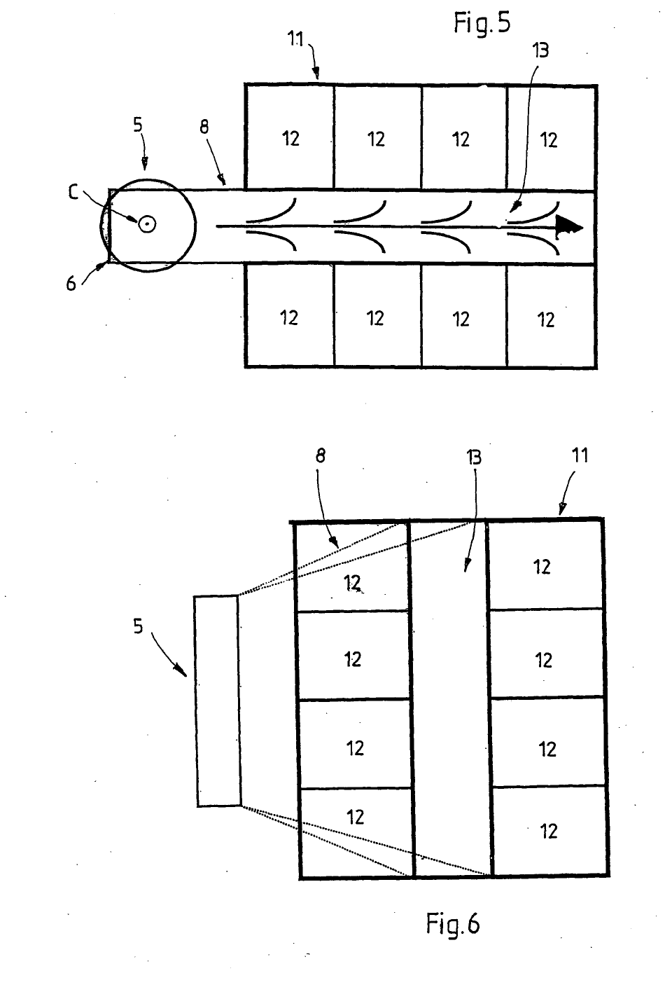

FIG. 6 is a schematic plan view of an arrangement rotated by 90° of the filter according to the invention,

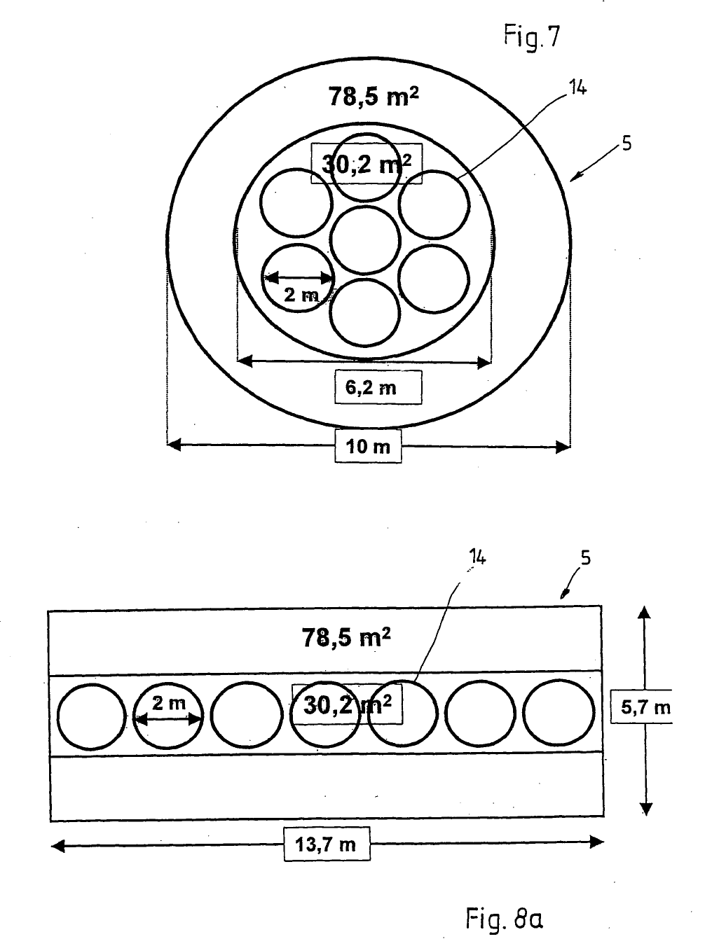

FIG. 7 is a schematic representation of the arrangement of the diffuser nozzles according to the state of the art and

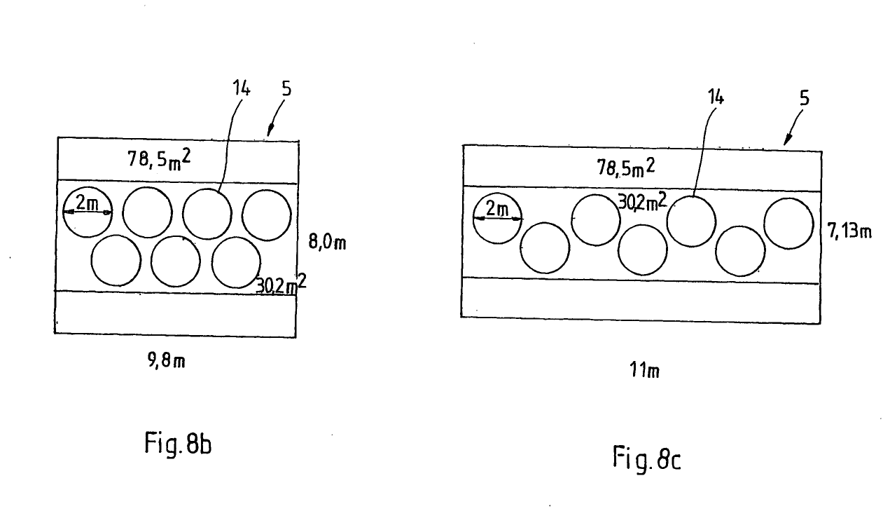

FIGS. 8a-c are a schematic representation of other possible different arrangements of the diffuser nozzles according to the present invention.

The flue gas purification device according to the state of the art, which is represented in FIGS. 1 and 2, comprises a vessel, which has two flue gas outlets 2, 3 that are placed side by side on the same level. The flue gas, which is generated in vessel 1 during a combustion, flows through said flue gas outlets 2, 3 into a flue gas pipe 16 and from this one into a transition piece 4, which has a rectangular cross section along the cutting line A-A represented in FIGS. 1 and 2 and a round cross section along the cutting line B-B. The non-purified flue gas flows from said transition piece 4 into a fluidized reactor 5, through which it flows in vertical direction, as indicated by the arrow C in FIG. 2, from below to above.

In said fluidized reactor 5, pollution gas components are separated from the non-purified flue gas by means of dry or quasi-dry separation methods. For this purpose, the fluidized reactor contains a sorbent, through which flows flue gas to be purified. Depending on the flow rate of the flue gas to be purified and on the particle size, a circulating fluid bed is formed inside the fluidized reactor. If the flow rate of the flue gas is increased, said fluidized reactor 5 will be operated with the so-called flue flow process. A reaction between the pollution gases contained in the flue gas to be purified and the sorbent takes place inside the fluid bed or inside the flue flow.

The flue gas leaves said fluidized reactor 5 together with sorbent particles that are carried along due to the flow rate, and loaded sorbent particles via a transition piece 6. Transition piece 6 has a round gas flow cross section in section D-D represented in FIGS. 1 and 2 and a rectangular cross section in section E-E. The flue gas flows from transition piece 6 via a hood 8 to a separation unit 7, in which the sorbent particles and loaded sorbent particles are separated from the flue gas flow. The purified flue gas leaves the flue gas purification device for example via a non represented suction draught, whereas the sorbent particles, which have been filtered out of the flue gas, are collected in said separation unit 7 and are returned or evacuated.

In FIGS. 3 and 4, a flue gas purification device according to the invention is represented. FIGS. 3 and 4 show a vessel 1, which has flue gas outlets 2, 3. The flue gas, which for example is generated during combustion in vessel 1 and which contains noxious matters, leaves said vessel 1 via said flue gas outlets 2, 3 and gets directly into a fluidized reactor 5 having a rectangular reactor cross section. As already described before with respect to the state of the art in FIGS. 1 and 2, the fluidized reactor 5 contains the sorbent, which reacts in the known way with the flue gas to be purified. The flue gas leaves said fluidized reactor 5 together with sorbent particles that are carried along due to the flow rate, and loaded sorbent particles and gets over a hood 8 to the separation unit 7. The end on the side of the vessel and the end on the side of the separation unit of said fluidized reactor 5 are formed as inlet connection piece 9 and outlet connection piece 10. The cross section of the flue gas purification device of FIGS. 3 and 4, through which the flue gas flows, has a rectangular cross sectional form over the entire course thereof. Due to this rectangular cross sectional form, no transition pieces having different cross sectional forms are necessary in contrast to the state of the art. Therefore, the flue gas purification device represented in FIGS. 3 and 4 requires a smaller building space in comparison to the state of the art of FIGS. 1 and 2.

It can also be seen in FIGS. 1 through 4, that the use of a fluidized reactor 5 having a rectangular reactor cross section is extremely suitable for retrofitting already existing flue gas purification devices. For such a retrofitting it is necessary to install the fluidized reactor 5 in the given building space between an already existing vessel 1 and an already existing separation unit 7. In such a retrofitting case, the geometry of said fluidized reactor 5 can be adapted to these narrow space conditions in that for example the depth T of reactor 5 is lengthened and in that the cross sectional area of the cross section, through which the flue gas flows, remains constant by simultaneously increasing the width F of the reactor (examples in FIGS. 8a through 8c).

Another possibility to make use of already existing components and to simultaneously save building space in the context of retrofitting a flue gas purification device is represented in FIGS. 5 and 6. FIG. 5 shows the arrangement of a fibre filter 11 according to the state of the art. The flue gas flows into the indicated direction through said fluidized reactor 5. The flue gas gets from said fluidized reactor 5 via transition piece 6 and hood 8 to separation unit 7, which is a fibre filter 11 in this embodiment. The flue gas gets from hood 8 to filter units 12 of said fibre filter 11, which are placed on both sides of hood 8, and flows through these filter units in the direction of the plane of projection, as indicated in FIG. 5. Inside said filter units 12, the sorbent particles, which are carried along with the flue gas flow and the loaded sorbent particles are separated from the flue gas, which leaves the fibre filter 11 via a non represented outlet.

FIG. 6 shows the arrangement of fibre filter 11 according to the present invention. It is visible that fibre filter 11 is placed with respect to fluidized reactor 5 such that it is rotated by 90° in the plane of projection. Said fibre filter 11 is composed of filter units 12 and a hood 8, which forms a supply channel 13. Due to the rectangular cross sectional form of fluidized reactor 5 it is possible by means of hood 8 by enlargement of the cross sectional width to place supply channel 13 in a transverse direction without the need to modify the geometry of the gas flow cross section thereof. Due to the arrangement of fibre filter 11, which is rotated by 90°, more building space is available in the context of a retrofitting for the installation of fluidized reactor 5 between an existing vessel 1 and an existing fibre filter 11.

FIG. 7 shows the arrangement of diffuser nozzles 14 in a fluidized reactor 5 according to the state of the art. For flue gas purification devices having a relatively small flue gas volume flow up to the order of about 400,000 standard m³, the fluidized reactor usually has one diffuser nozzle only. FIG. 7 shows a fluidized reactor 5, which is dimensioned for flue gas volume flows of >400,000 standard m³. Seven diffuser nozzles are placed in the round cross section of fluidized reactor 5, since this number of diffuser nozzles enables to use the cross sectional area, which is available in the reactor, in an optimum way. The chosen exemplary reactor space of fluidized reactor 5 presents a total cross section of 78.5 m², for the arrangement of the diffuser nozzles, a diameter of 6.2 m is available.

FIG. 8 represents different cross sectional forms of the reactor space of a fluidized reactor having a rectangular cross section, wherein the total cross sectional area of the rectangular fluidized reactor 5 corresponds to the cross sectional area of the fluidized reactor 5 having a round cross section, which is represented in FIG. 7. The cross sectional forms represented in FIGS. 7 and 8 are thus suitable for equal flu gas volume flows. In FIGS. 8a, b, c, different arrangements of the diffuser nozzles 14 are represented.

One can see that, depending on the arrangement of diffuser nozzles 14, the dimensions of the reactor space and thus also the outer dimensions of fluidized reactor 5 can be varied in a wider range, while maintaining the same cross sectional area and thus the same flue gas volume flow, such that fluidized reactor 5 can be advantageously retrofitted in already existing flue gas purification devices, also under different, narrow space conditions.

### LIST OF REFERENCE NUMERALS

1 vessel

2 flue gas outlet

3 flue gas outlet

4 transition piece angular/round

5 fluidized reactor

6 transition piece round/angular

7 separation unit

8 hood

9 inlet connection piece

10 outlet connection piece

11 fibre filter

12 filter units

13 supply channel

14 diffuser nozzle

15 pre-separation unit

16 flue gas pipe

A-A sectional line

B-B sectional line

C flow direction

D-D sectional line

E-E sectional line

B width of the fluidized reactor

T depth of the fluidized reactor

1. A flue gas purification device comprising a fluidized reactor and a separation unit, which is placed downstream of said fluidized reactor, wherein the reactor space of said fluidized reactor presents, orthogonal to the gas flow direction, an essentially rectangular cross section, the relation of width with respect to depth of which can be variably set depending on the cross sectional size, which is required for the flue gas volume flow to be purified.

2. A flue gas purification device according to claim 1, wherein said fluidized reactor presents an essentially rectangular outer contour.

3. A flue gas purification device according to claim 1, wherein the rectangular geometry of the reactor space corresponds to the rectangular dimensions of flue gas channels of upstream and/or downstream units of the flue gas purification device.

4. A flue gas purification device according to claim 1, wherein that said fluidized reactor at least comprises one diffuser nozzle.

5. A flue gas purification device according to claim 4, wherein said fluidized reactor comprises diffuser nozzles, which are placed in series.

6. A flue gas purification device according to claim 4, wherein said diffuser nozzles are juxtaposed in one or more rows.

7. A flue gas purification device according to claim 4, wherein that said fluidized reactor comprises diffuser nozzles placed in an offset arrangement.

8. A flue gas purification device according to claim 4, wherein that said diffuser nozzle has a rectangular cross section.

9. A flue gas purification device according to claim 1, wherein that said fluidized reactor can be operated with a circulating fluid bed.

10. A flue gas purification device according to claim 1, wherein that said fluidized reactor is a flue flow absorber.

11. A flue gas purification device according to claim 1, wherein that said separation unit is an electric filter.

12. A flue gas purification device according to claim 1, wherein that said separation unit is a fibre filter.

13. A flue gas purification device according to claim 11, wherein a mechanical pre-separation unit is placed in a flue gas channel between fluidized reactor and separation unit.

14. A flue gas purification device according to claim 12, wherein the fibre filter is placed, in comparison to the arrangement according to the state of the art, such that it is rotated by 90° around the vertical.
